(19) United States
(12) Patent Application Publication
(10) Pub. No.: US 2003/0181835 A1
(43) Pub. Date: Sep. 25, 2003

(54) Miniature finger ring vibrator

(76) Inventor: Eric A. Klein, Mountain View, CA (US)

Correspondence Address: Thomas M. Freiburger, 25th Fl., 650 California Street, San Francisco, CA, 94108, US

(21) Appl. No.: 10/304,180

(22) Filed: Nov. 25, 2002

Related U.S. Application Data
(60) Provisional application No. 60/367,106, filed on Mar. 25, 2002.
(60) Provisional application No. 60/367,108, filed on Mar. 25, 2002.

(51) Int. Cl. A61H 23/02

(52) U.S. Cl. 601/72

(57) ABSTRACT

A miniature sexual aid device is embodied in a battery powered electric vibrator which attaches to the user's finger. The sexual aid device includes a vibration motor, a button cell battery, a moisture resistant housing that contains the motor and battery, and a strap or ring for attaching the device to the finger or to another appendage. The motor is mounted transversely and contiguously with the battery. The retaining ring or strap may be offered in a variety of fixed sizes or may be adjustable to fit a variety of finger sizes. The device is no larger than some jewelry rings and may be shaped, colored, and ornamented to be worn on the finger as jewelry.

### BACKGROUND OF THE INVENTION

This application claims benefit of provisional Serial Nos. 60/367,106 and 60/367,108, both filed Mar. 25, 2002. This invention relates to a vibrating sexual aid device, specifically to a miniature device that attaches to a single finger of the hand or to another body appendage.

Battery powered vibrating devices which attach to the hand are well known. These known devices deliver strong vibration suitable for muscle or gum massage.

The smallest known device appears to be a device 3 inches long weighing more than 1 ounce. The relatively large size of these devices have several disadvantages when used as sexual aids: they interfere with normal use of the hand; they are “machine-like” and can be obtrusive; the vibration is unnecessarily strong for sexual stimulation and may cause numbness; it is impractical to wear more than one on each hand. None of the known devices uses a transversely mounted vibration motor contiguous with the battery.

The known devices deliver vibration either by applying the vibrating device directly to the area being vibrated or by transmitting the vibration through the user's fingers to the area being vibrated. These devices have the disadvantage that they are suitable for use in only one mode; they cannot be used to deliver vibration both by direct application of the device and by transmitting the vibration through the user's finger.

Some of these devices have been described in prior art patents. Examples of these patents include U.S. Pat. Nos. 6,203,509, 5,601,529, 5,519,292, 4,116,233, 3,623,481, 2,918,055, 2,350,817, and 2,286,089.

U.S. Pat. No. 6,203,509 describes a massaging device which attaches to one finger of a user. This device is slightly wider than the finger and approximately three times as long as its width. The device includes a motor with unbalanced weight, housing, finger engaging retainer and an attached panel which acts as the massaging surface. Defining the front of the motor as the end from which the shaft extends, the batteries are situated to the rear of (behind) the motor. The finger contacts the opposite side of the device from the massaging surface in such a way that the fingertip is covered, precluding transmission of vibration through the finger.

U.S. Pat. Nos. 5,601,529 and 5,519,292 show finger massage devices which are mounted on the hand and wrist of the user. Both incorporate control enclosures which may be used to vary certain parameters of the vibration including the intensity, frequency, etc. Both devices transmit vibration through the fingers.

U.S. Pat. No. 4,116,233 describes a hand sized device and has a handle to accommodate the hand of a user with the palm of the hand on the housing. A motive device imparts vibration to a massage ball. The massage ball applies vibration directly to the area being vibrated.

U.S. Pat. No. 3,623,481 describes a gum massage implement which attaches to one finger of a user. This device has a torpedo shape with diameter greater than that of a finger and length more than four times its diameter. The device includes a motor with unbalanced weight, housing and a finger engaging retainer. Defining the front of the motor as the end from which the shaft extends, the batteries are situated to the rear of (behind) the motor. The device transmits vibration through the finger to the gums.

U.S. Pat. Nos. 2,918,055 and 2,350,817 describe hand massagers which attach to several fingers of the user. These devices are powered via electric cords rather than by batteries. These devices extend upwardly from the hand for several inches. Both devices transmit vibration through the hands to impart vibration to a subject during massage.

U.S. Pat. No. 2,286,089 describes a hand attachment means for a vibrator. This device attaches to three fingers of a hand.

### SUMMARY OF THE INVENTION

A miniature sexual aid device of the invention comprises a battery powered electric vibrator which attaches to the user's finger. The sexual aid device includes a vibration motor, a button cell battery, a moisture resistant housing that contains the motor and battery, and a strap or ring for attaching the device to the finger. The motor is mounted transversely and contiguously with the battery. The device is no larger than some jewelry rings and may be shaped, colored, and ornamented to be worn on the finger as jewelry, i.e. generally shaped as a gem-bearing ring.

The preferably two part housing of the device is roughly cylindrical in shape. In a preferred embodiment, rotating the upper housing in relation to the lower housing operates an on-off switch and, if rotated further, twists open the housing to provide access to the battery. An alternative type of switch can be employed if desired. The housing, exclusive of the retaining ring or strap, preferably is smaller than a cylinder 0.75 inch in diameter and 0.75 inch high and weighs less than 0.5 ounce. The housing is moisture resistant.

The retaining ring or strap may be offered in a variety of fixed sizes or may be adjustable to fit a variety of finger sizes. It may be sized to fit or adjustable to fit on another body appendage, such as a penis or a tongue.

Accordingly several objects and advantages of the invention are:

(a) to provide a vibrating sexual aid which attaches comfortably to the finger;

(b) to provide a finger mounted vibrating sexual aid which attaches securely to various size fingers;

(c) to provide a finger mounted vibrating sexual aid which can be rotated on the finger so that the vibrating surface faces either the palm side or the back side of the hand, and to provide a finger mounted vibrating sexual aid which may be used to deliver vibration both by direct application of the device or by transmitting the vibration through the user's finger;

(d) to provide a finger mounted vibrating sexual aid which may be fabricated and ornamented in such a way as to be worn as jewelry in the appearance of a gem-bearing ring;

(e) to provide a miniature finger mounted vibrator which, due to its small size, is amusing, unobtrusive and non-threatening, and which causes minimal interference with normal movement of the hand and fingers;

(f) to provide a miniature finger mounted vibrator which is small enough that several may comfortably be worn on the same hand and even on the same finger;

(g) to provide a finger mounted vibrating sexual aid which vibrates strongly enough to be stimulating but not so strongly that it causes numbing.

(h) to provide a vibrating device with the above features and advantages and attachable to another appendage such as a penis or a tongue.

Further objects and advantages of the invention will become apparent from a consideration of the drawings and the ensuing description.

### DESCRIPTION OF THE DRAWINGS

FIG. 1 is a perspective view of one embodiment of the invention, with a closed finger ring.

FIG. 2 is an exploded perspective view of the invention, with a closed finger ring, indicating assembly.

FIG. 2A is an exploded perspective view showing a subassembly of a battery and a vibrator motor of a different type from what is shown in FIG. 2.

FIG. 3 is a perspective view of the invention showing integral closed finger rings of various sizes.

FIG. 4 is a perspective view of the invention with interchangeable closed finger rings of various diameters.

FIG. 5 is a perspective view of the invention, with an open finger ring.

FIG. 6 is a perspective view showing another embodiment, with a flexible band to engage the finger or other appendage.

FIG. 7 is a plan view showing a detail of the FIG. 6 embodiment.

FIG. 8 is a perspective view showing a further embodiment, with another type of band.

FIG. 9 is a view showing the FIG. 8 embodiment engaged on a body appendage.

FIG. 10 is a perspective view showing another modified embodiment, with a different form of ring band.

FIG. 11 is a plan view showing a double vibrator ring embodiment and indicating a means of securement to a body appendage.

FIG. 12 is a perspective view showing another embodiment, again with a different means of engagement, in this case a plastic buckle essentially integral with the housing of the ring.

FIG. 13 is a cut-away sectional view in perspective showing the ring of FIG. 12.

### DESCRIPTION OF PREFERRED EMBODIMENTS

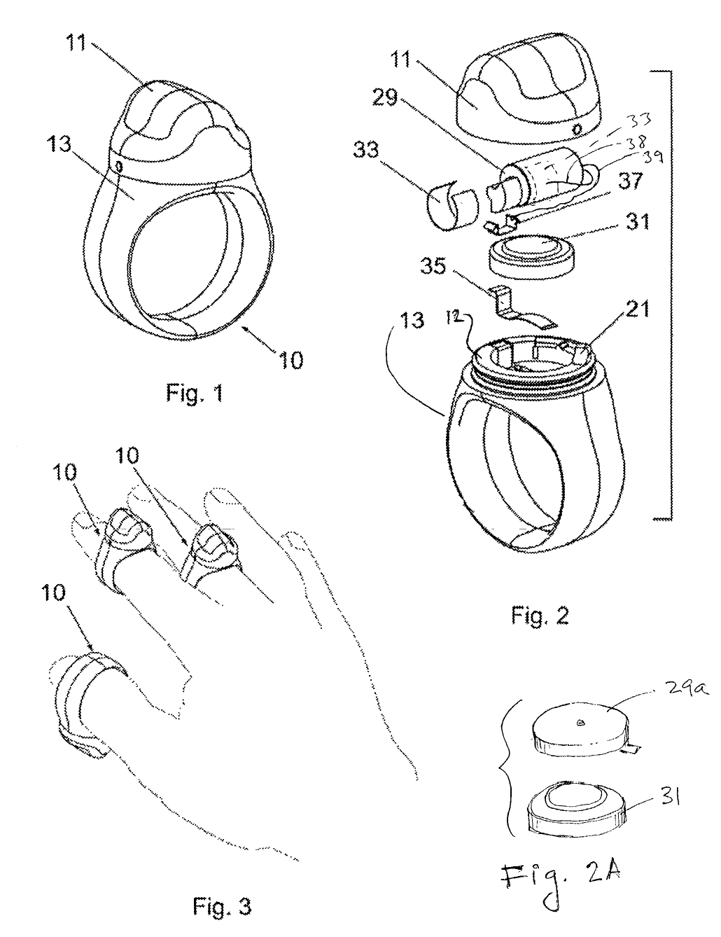

FIG. 1 shows in perspective a preferred embodiment of a vibrator ring 10. The exterior of the device is a moisture resistant housing which separates into an upper or motor housing 11 and a lower or battery housing 12 (better seen in FIG. 2). The upper housing and lower housing twist apart to enable battery replacement and snap together to reassemble the device. A closed finger ring or band 13 is permanently attached to the lower housing 12. (“Upper” and “lower” are only used for convenience of description and not to imply particular orientation of the device in use.) The housings can be referred to as first and second housings, or first and second housing components, or the assembled two housings can simply be referred to as a housing. Reference to two housings includes construction wherein one “housing” is simply a closure plate.

FIG. 2 is an exploded perspective view of the vibrator. The upper housing 11 contains a transversely mounted vibrator motor 29, a negative battery contact 33, and a switch contact 37. The position for the contact 33 is shown in dashed lines. A negative motor wire 38 is connected to the negative battery contact 33 and a positive motor wire 39 is connected to switch contact 37. The lower battery housing 12 contains a battery 31 and a positive battery contact 35. The positive battery contact 35 extends upward from the battery housing 12 in such a way that it may touch the switch contact 37 when the unit is assembled. Rotating the upper housing 11 in relation to the lower housing 12 powers the device on and off. In this embodiment, the closed finger band 13 is integral with the lower housing 12. The vibrator is attached to the hand by inserting a finger through the closed band 13. When assembled, the battery 31 is mounted alongside, rather than behind, the motor 29, as shown in FIG. 2. The motor 29 resides in a recess (not shown) of the upper housing 11, and the motor's negative contact 33 is in direct contact with the battery when the device is assembled.

The vibrator motor 29 may be of a known type used in silent pagers, usually known as a vibration motor or pager motor. For example, the motor can be one identified as “cylindrical DC motor of permanent magnet”, Model OTL-6SL, manufactured by Jinlong Machinery & Electronic co., Ltd. Of Yeuquing, Zhejiang, China. This preferred cylindrical motor 29 is about 10 mm in length and about 6 mm in diameter. Preferably the vibrator motor is less than about 20 mm in length and less than about 10 mm in width or diameter. Note that the motor can be of the flat, pancake shape of pager motor if desired, oriented similarly to the battery. Such a vibrator motor can be, for example, a pager motor from Tokyo Parts Industries Corp., designated Type FM23, FM25, FM31, FM34, or FM29 depending on the battery used. FIG. 2A shows the subassembly of the battery 31 and a pancake vibrator motor 29a in exploded view. The two are to be assembled contiguously. In this case the upper housing or ring crown 11 is modified accordingly.

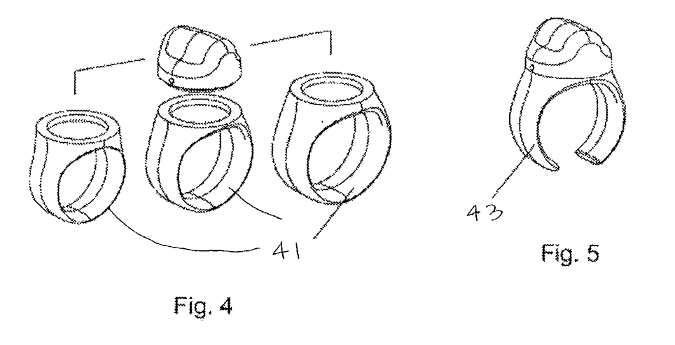

FIG. 3 is a perspective view showing three instances of the vibrator 10, each with a closed finger ring of a different diameter. In this embodiment the closed ring is integral with the lower housing. The leftmost ring is shown worn near the fingertip with the housing facing toward the palm for delivering vibration by direct application of the device. The middle and rightmost rings are worn facing toward the back of the hand in a position suitable for transmitting vibration through the user's finger.

FIGS. 4-7 illustrate various methods and implementations for securing the vibrator to fingers or appendages of differing size. Each of the methods has some advantage over the others and it is foreseen that devices using each securing means as well as others, may be commercially developed.

FIG. 4 shows an embodiment of the invention with interchangeable or snap-on finger rings 41 of various diameters. FIG. 5 shows the invention with an open finger ring 43. The open finger ring is formed from a resilient plastic which stretches open for a larger finger and contracts to grasp a smaller finger.

In operation the user inserts a finger into the ring or straps the device to the finger and powers the device on by twisting the upper housing. Depending on how the user chooses to use the device it may be positioned at the top, middle, or base of the finger and may face inward or outward. Multiple rings may be worn on the same hand and even on the same finger. The device can be worn on other appendages of the body as well. Testing has shown that a watch battery can power the device for a period of between 30 and 90 minutes depending on the storage capacity of the battery and the power consumption of the motor.

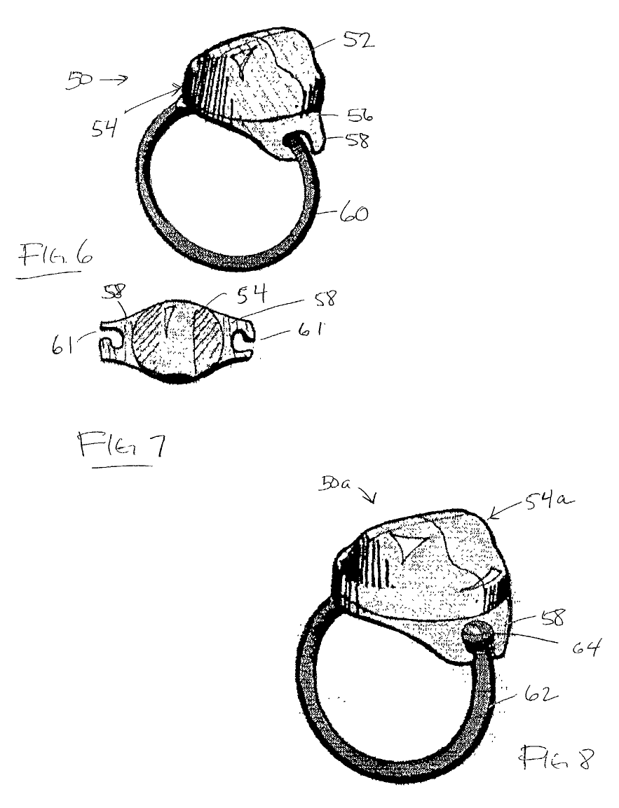

FIG. 6 shows a modified form of ring device 50, again having a ring crown 52 similar to what is shown in the earlier drawings, in the general shape and appearance of a gem-bearing finger ring. The means of attachment to the body appendage is different in FIG. 6. The housing, which is generally identified as 54, and in particular a lower housing 56 in the preferred embodiment wherein two housings come together to make the ring crown 52, has a pair of opposed brackets or ears 58 which support a flexible rubbery or elastomeric band, preferably in the form of a flexible O-ring 60. O-rings can be provided in various sizes, to fit over any of the fingers or on other appendages of the body, such as on the tongue or the penis. In this embodiment the O-ring comprises a complete circle. FIG. 7 shows a detail of the manner in which the O-ring is captured on the ring housing. The two wings or ears 58 have openings 61 which allow the O-ring to be forced and compressed through a narrow entryway and into a larger region of the opening as shown. In this way, the O-ring is captured in position, with a section of the O-ring extending under the bottom of the ring housing in use.

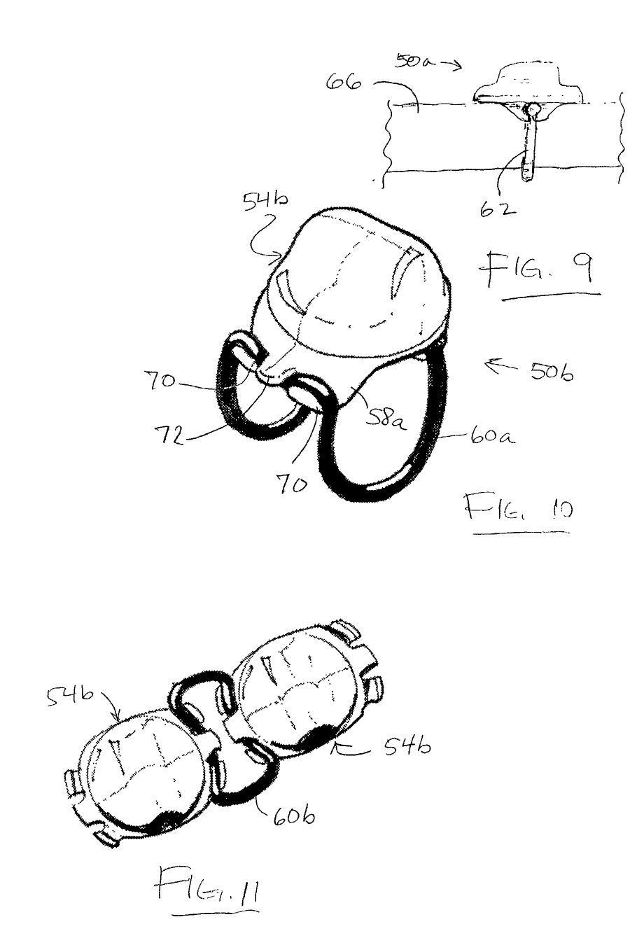

FIG. 8 is a perspective view showing essentially the same ring housing 54a, which can be identical to the ring housing 54 but using a different form of flexible band 62. The wings 58 on this embodiment of the housing can be identical to those shown in FIGS. 6 and 7, but in this case the openings in which the rubbery, elastomeric band 62 are inserted could be more symmetrical if desired (openings not specifically seen, occupied by band in FIG. 8). Here, the flexible band is similar to a truncated O-ring with knobs at its two ends. Once the flexible band 62 is inserted onto the wings 58 of the ring device, the knobs 64 prevent the band from pulling through. These band components 62, shaped somewhat like flexible barbells, can be provided in several different lengths for fitting on different sizes of appendages.

FIG. 9 is a schematic elevation view showing a ring device 50a of the type shown in FIG. 8, as fitted on a body appendage 66. The body appendage could be, for example, a finger, a penis or a tongue. Note that the flexible band 62 can be selected in appropriate length so as to be as tight or loose as desired for the particular situation.

FIG. 10 shows another modified ring device 50b illustrating another means of retention of the ring to the body appendage. In this case a flexible band, a complete circle such as an elastomeric O-ring 60a, is held in a double-looped fashion on the two wings or ears 58a of the ring housing 54b. Each wing 58a is in the form of a clip which pinches the O-ring as shown. The clip may be formed with three projections 70 and 72, such that the O-ring is forced tightly between the outer two projections 70 and the slightly displaced middle projection 72. Again, the O-rings 60a can be provided in a large number of different sizes for different sized users and for different body appendages.

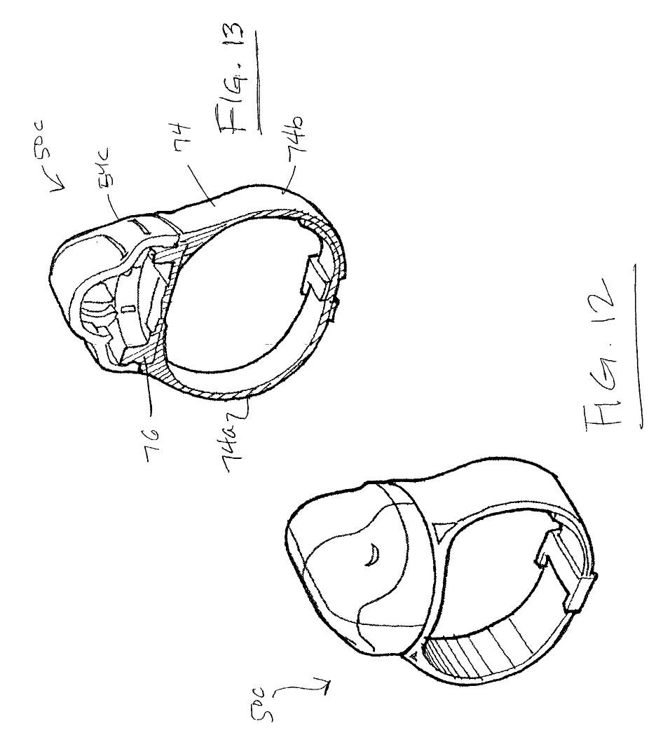

FIG. 11 illustrates usage of two ring housings 54b to fit on a single appendage. Here, a smaller O-ring 60b is used, connected to the clips of the two ring housings as shown. When the two ring housings are secured around the appendage, a similar O-ring will be used to attach them together at their opposite sides.

FIGS. 12 and 13 show another similar ring device 50c which can be similar in all respects to the above, except for the manner of retention to the body appendage. Here, a plastic buckle 74 which is essentially integral with the ring housing 54c, more preferably with a lower housing shown at 76, has two straps 74a and 74b which buckle together around the appendage. This plastic buckle device 74 can be a plastic which is flexible but which generally retains its shape.

The sectional view of FIG. 13 shows that the plastic buckle device 74 may be not technically integral with the lower housing 76, but rather secured to it by adhesion. Alternatively, the plastic buckle device 74 may be of a different material from the lower housing 76 but still co-molded such that the two components are, in fact, integrally formed as a single piece after such co-molding process. The sectional view of FIG. 13 shows the ring housing empty, without the vibrator and battery components, for purposes of clear illustration.

Accordingly, the miniature vibrator of this invention provides a small, lightweight vibrator that attaches securely yet comfortably to a finger or other body appendage such as a tongue or penis. The vibrator is quick and easy to attach and detach, and causes minimal interference with normal movement of the hand or appendage. The vibrator's small size makes it unobtrusive and non-threatening. The device may be used to deliver vibration both by direct application of the device or by transmitting the vibration through the user's finger or other appendage. It contains few parts and may be inexpensively produced.

Although the description above contains many specificities, these should not be construed as limiting the scope of the invention but as merely providing illustrations of some of the presently preferred embodiments of this invention. Thus, the scope of the invention should be determined by the appended claims and their legal equivalents, rather than by the examples given.

I claim:

1. A miniature finger ring vibrator, comprising:
a first housing,
a second housing, having a recess containing a battery,
the first housing being connected to the second housing, with the battery and a vibrator motor contained by the two housings,
electrical connections within the two housings and connected to the vibrator motor and to the battery, enabling the device to be turned on or off to activate or deactivate the vibrator motor, by manipulation of one housing relative to the other housing, and
a band connected to one of the housings and being configured to engage on a finger.

2. The device as described in claim 1, wherein said one housing comprises a ring crown generally in the shape of a gem-bearing finger ring.

3. The device as described in claim 1, wherein the band comprises an open band.

4. The device as described in claim 1, wherein the band comprises an elastic securing strap.

5. The device as described in claim 1, wherein the band comprises an elastomeric strap secured to one of the housings.

6. The device as described in claim 5, wherein the band comprises an O-ring.

7. The device as described in claim 1, wherein the first housing comprises an upper housing and includes a switch contact and substantially contains the vibrator motor, wherein the second housing comprises a lower housing and has a battery contact in contact with the battery, and wherein the upper housing is rotatable relative to the lower housing such as selectively to place the switch contact in contact with the battery contact to turn the device on.

8. A miniature vibrator for wearing on the human body, comprising:
a first housing,
a second housing, having a recess containing a battery, the first housing being connected to the second housing, with the battery and a vibrator motor contained by the two housings,
electrical connections within the two housings and connected to the vibrator motor and to the battery, enabling the device to be turned on or off to activate or deactivate the vibrator motor, by manipulation of one housing relative to the other housing, and
a band for attachment to an appendage of the human body, secured to one of the housing.

9. The device as described in claim 8, wherein said one housing comprises the second housing containing the battery.

10. The device as described in claim 8, in the general shape and appearance of a gem-bearing ring.

11. The device as described in claim 8, wherein the band comprises an elastomeric strap.

12. The device as described in claim 11, wherein the band comprises and O-ring.

13. The device as described in claim 8, wherein the band comprises a molded plastic buckle substantially integral with one of the housings.

14. The device as described in claim 13, in the general shape and appearance of a gem-bearing finger ring.

15. The device as described in claim 8, wherein the first housing comprises an upper housing and includes a switch contact and substantially contains the vibrator motor, wherein the second housing comprises a lower housing and has a battery contact in contact with the battery, and wherein the upper housing is rotatable relative to the lower housing such as selectively to place the switch contact in contact with the battery contact to turn the device on.

16. A sexual aid device, comprising:
a moisture resistant housing containing a battery and a vibrator motor,
electrical connections between the battery and the vibrator motor and including an on-off switch operable from outside the housing enabling the device to be turned on or off to activate or deactivate the vibrator motor,
a band secured to the housing and appropriately sized to engage over a selected human appendage, and
the device being in the general shape of a gem-bearing finger ring.

17. The device as described in claim 16, wherein the band comprises an elastomeric band.

18. The device as described in claim 17, wherein the band comprises an O-ring.

19. The device as described in claim 16, wherein the housing comprises upper and lower connected housings, and wherein the lower housing includes a pair of wings extending in opposed directions, each with an opening sized to tightly receive a band when forced into the opening, the band comprising an elastomeric, rubbery band.

20. The device as described in claim 19, wherein the band is an O-ring.

21. The device as described in claim 19, wherein the elastomeric band comprises a strip of stretchable material with an enlargement or knob at each end.

22. The device as described in claim 16, wherein the band comprises a molded plastic buckle which has a pair of straps that connect together, the molded plastic buckle being essentially integral with the housing.

23. The device as described in claim 22, wherein the lower side of the housing and the plastic buckle are of different materials co-molded together.

24. The device as described in claim 16, wherein the band is sized to closely fit over a finger.

25. The device as described in claim 16, wherein the band comprises an elastomeric strap, sized to fit tightly over a human tongue to retain the sexual aid on the tongue.

26. The device as described in claim 16, wherein the band comprises a stretchable, rubbery elastomeric band sized to fit tightly over a penis.

27. The device as described in claim 16 wherein the vibrator motor is a pancake type motor and the battery is round and mounted adjacent to and generally coaxially with the pancake type motor.

28. A sexual aid device, comprising:
a moisture resistant housing containing a battery and a vibrator motor,
the motor being mounted transversely and contiguously with the battery, with electrical connections between the battery and the vibrator motor and including an on-off switch operable from outside the housing enabling the device to be turned on or off to activate or deactivate the vibrator motor, and
a band secured to the housing and appropriately sized to engage over a selected human appendage.

29. The device as described in claim 28, wherein the band comprises an elastomeric band.

30. The device as described in claim 29, wherein the band comprises an O-ring.

31. The device as described in claim 28, wherein the housing comprises upper and lower connected housings, and wherein the lower housing includes a pair of wings extending in opposed directions, each with an opening sized to tightly receive a band when forced into the opening, the band comprising an elastomeric, rubbery band.

32. The device as described in claim 31, wherein the band is an O-ring.

33. The device as described in claim 31, wherein the elastomeric band comprises a strip of stretchable material with an enlargement or knob at each end.
